(19) United States
(12) Patent Application Publication
(10) Pub. No.: US 2011/0201355 A1
(43) Pub. Date: Aug. 18, 2011

(54) Method and Device for Location-Based Call Management

(75) Inventor: Andreas Hansson, Stockholm (SE)

(73) Assignee: TELEFONAKTIEBOLAGET LM ERICSSON (PUBL), Stockholm (SE)

(21) Appl. No.: 13/126,007

(22) PCT Filed: Oct. 27, 2008
(86) PCT No.: PCT/SE2008/000611

§ 371 Date: Apr. 26, 2011

(51) Int. Cl. H04W 24/00

(52) U.S. Cl. 455/456.1

(57) ABSTRACT

A location server (208) and a method for evaluating the location of a user equipment (UE) (102; 202) in relation to at least one geographical zone related to the UE, is disclosed. In addition, a location server (506, 706) and a method for processing of a zone-related service request, is disclosed. Also a method for provisioning cell-independent geographical zones is disclosed. Based on location information of the UE (102; 202), and zone information about a cell-independent geographical zone, it is determined whether the zone is overlapping the location of the UE (step 314). The cell-independent geographical zones can be provided using a zone provisioning protocol (ZPP). Cell planning is facilitated since the zones are per definition independent of defined cells. The development of location-based services is hence provided a promising springboard.

### TECHNICAL FIELD

The present invention relates in general to a method and device for location based call management and in particular to a method and device for call management based on the true geographical location of a user.

### BACKGROUND

Techniques for providing evaluation of the location of mobile station or user equipment for non-time sensitive services using spatial triggers are well known.

Charging based on location is known to be a possible service within Location Services (LCS), which is described in the 3GPP TS 22.071 V7.4.0, LCS Description. Within this specification, charging based on location is however highly conceptual and no description on how to implement a corresponding service has been formulated.

Nevertheless, there are a few Location Based Charging (LBC) deployments worldwide considering the worldwide deployments of mobile networks. Typically, a LBC deployment is implemented by letting certain cells in the network, or rather a group of cells such as a Location Areas (LA), correspond to a certain charging tariff. By simply scanning a database comprising Location Areas and their corresponding tariffs, the rate of a call from a certain Location Area can be determined at the call setup.

Current charging systems may have a functionality to support charging based on the location of User Equipments (UEs). By detecting in which cell the UE is located when setting up the call, and by using cell information it can be determined whether this particular cell is associated with a specific tariff or not, and whether it belongs to a LA that is associated with a specific tariff or not. In case a particular tariff applies, this tariff is then used for the entire time duration of the phone call.

If a tariff area, i.e. the area in which a tariff is applicable, is based on the serving cell(s), a problem arises when the cell structure is modified. As a consequence to cells being added, moved, split, or otherwise altered in any way, gross portions of the tariff structure might have to be changed, in order to maintain the same tariff for unchanged physical positions from which the service may be used.

One way to circumvent this problem is to define geographical areas that are very large in size which trigger customized call rates. Typically, such an area might be a major city, a state, or a province.

The strong dependence on the cellular network structure makes it inconvenient to use small areas such as specific cells, due to frequent cell re-homing, that is transfer of Radio Base Stations (RBSes) from an old Radio Network Controller (RNC) that is congested to a new RNC. This procedure is often a tedious task and may require reconfiguration of both the radio and the transport networks, which could heavily impact the traffic on the connected RBSes.

There is hence a need for a location-based service with greater flexibility with regard to customer needs, than can be provided with current alternatives.

### SUMMARY

An object is to obviate at least some of the above disadvantages and provide an improved location based call management for communications systems.

According to a first aspect, there is provided a method of evaluating the location of a user equipment (UE) in relation to at least one geographical zone related to the UE, in a service enabling communication system. The method comprises obtaining location information of the UE, obtaining zone information about the at least one geographical zone, evaluating the obtained location information in relation to the at least one geographical zone, by determining whether the location of the UE at least partly is overlapping the at least one geographical zone, or not, and providing a location evaluation response, wherein the response is dependent on the step of determining whether the location of the UE at least partly is overlapping the at least one geographical zone.

Said method may also comprise obtaining the subscriber identity number for the UE. It may also comprise obtaining zone information for the subscriber identity number, and evaluating the obtained zone information for the subscriber identity number by determining whether the location of the UE at least partly is overlapping the at least one geographical zone for the subscriber identity number, or not.

The subscriber identity number of the method may also comprise the Mobile Station International Subscriber Directory Number (MSISDN).

Providing a location evaluation response of the method, may also comprise providing the zone type of a geographical zone that is overlapping the location of the UE.

Providing a location evaluation response of the method, may also comprise providing the identity of a geographical zone that is overlapping the location of the UE.

The location of the UE within determining whether the location of the UE at least partly is overlapping the at least one geographical zone, may also comprise a position area of the UE.

The at least one geographical zone within the method may also comprise the at least one cell-independent geographical zone.

According to a second aspect, there is provided a method of processing of zone-related service requests, said method comprising obtaining a zone-related service request from a zone provisioning system, processing said zone-related service request in relation to a subscriber-related zone database, providing a zone-related service response to the zone provisioning system. This method enables management of the subscriber-related zone database.

The method of processing of zone-related service requests may also comprise sending a location information request to a location node, and obtaining a location information response from a location node. The step of processing said zone-related service request might also be processed in relation to the obtained location information response from the location node.

The method of processing of zone-related service requests may also comprises a Gateway Mobile Location Centre (GMLC).

The service request and the service response of the method of processing of zone-related service requests, may also comprise a service message request and a service message response, respectively.

Zone within the method of processing of zone-related service requests may refer to a cell-independent geographical zone.

According to a third aspect, there is provided a location server for evaluating the location of a user equipment (UE) in relation to at least one cell-independent geographical zone related to the UE, adapted to be connected to a service enabling communication system. The location server comprises an obtaining unit arranged to obtain location information on the UE, an evaluation unit arranged to evaluate the obtained location information in relation to the at least one cell-independent geographical zone related to the UE, and a sending unit arranged to respond to the obtained location information on the UE.

The location server may also comprise a memory unit having a subscriber-related database of cell-independent geographical zones.

The memory unit of the location server may further comprise at least one cell-independent geographical zone for the subscriber identity number, and evaluation unit may be arranged to evaluate the obtained location information in relation to the at least one cell-independent geographical zone for the subscriber identity number related to the UE.

The sending unit of the location server may further be arranged to provide the zone type of a geographical zone that is overlapping the location of the UE.

The sending unit of the location server may further be arranged to provide the zone identity of a geographical zone that is overlapping the location of the UE.

The location of the UE for the location server may comprise a position area of the UE.

According to a fourth aspect, there is provided a location server for processing of a zone-related service request, adapted to be connected to a service enabling communication system. Said location server comprises an obtaining unit arranged to receive the service request that is related to a geographical zone, a processor arranged to process said zone-related service request in relation to a subscriber-related zone database, and a sending unit arranged to respond to the obtained service request. This location server enables management of the subscriber-related zone database.

The location server for processing of a zone-related service request may further comprise a memory unit arranged to comprise the subscriber-related zone database.

Zone may refer to cell-independent geographical zone within the location server for processing of a zone-related service request.

The location server for processing of a zone-related service request may further comprise the location server for evaluating the location of a user equipment (UE). The location server for processing of a zone-related service request may be adapted to be connected to and for providing services in a service enabling communication system.

The location server for evaluating the location of a user equipment (UE) may further comprise the location server for processing of a zone-related service request. The location server for evaluating the location of a user equipment (UE) may be adapted to be connected to and for providing services in, a service enabling communication system.

The location server for processing of a zone-related service request may be the same location server as the location server for evaluating the location of a user equipment (UE).

The location server for processing of a zone-related service request may be different from the location server as the location server for evaluating the location of a user equipment (UE).

According to a fifth aspect, there is provided a method of provisioning of services related to a subscriber-related zone database, for which the zone is a cell-independent geographical zone, the method comprising obtaining subscriber-related input data, providing a zone-related service request dependent on the obtained input data, to a location server, obtaining a zone-related service response from the location server, and providing the zone-related service response. This method enables management of the subscriber-related zone database.

Providing a zone-related service request in the method of provisioning may comprise providing a zone-related service message request, and obtaining a zone-related service response may comprise obtaining a zone-related service message response.

Zone is herein defined as an area that can be characterized by specific geographic information in the form of latitude, longitude and extension, such as a radius.

It should be emphasized that the term “comprises/comprising” when being used in the specification is taken to specify the presence of the stated features, integers, steps or components but does not preclude the presence or addition of one or more other features, integers, steps or components or groups thereof.

### BRIEF DESCRIPTION OF THE DRAWINGS

In order to explain the invention and the advantages and features thereof in more detail, embodiments of the invention will be described below, references being made to the accompanying drawings, in which

FIG. 1 presents parts of a communication system relevant to the present invention:

FIG. 2 presents a signal diagram illustrating a signal flow for location evaluation according to some embodiments of the present invention;

FIGS. 3A and 3B present a flow-chart illustrating method steps of location evaluation according to at least some embodiments of the present invention;

FIG. 4 presents a block diagram of a location server according to some embodiments of the present invention;

FIG. 5 presents a signal diagram illustrating a signal flow for zone addition service request according to some embodiments of the present invention;

FIG. 6 presents a flow chart illustrating method steps of a zone addition service request according to some embodiments of the present invention;

FIG. 7 presents a signal diagram illustrating a signal flow for a zone addition service request according to some embodiments of the present invention;

FIG. 8 presents a protocol structure illustrating a layered protocol structure according to some examples of the present invention;

FIG. 9 presents a flow-chart illustrating method steps of service provisioning according to at least some embodiments of the present invention; and

FIG. 10 presents a flow-chart illustrating method steps of processing of a service request according to some embodiments of the present invention.

### DETAILED DESCRIPTION

The present invention relates in part to the evaluation of a user's location at call set up, in terms of true geographical areas or zones. Such an evaluation may be used to determine specific parameters, for example the call rate for the call.

Geographical areas or zones herein are true geographical areas and zones, and can be defined by their geographical location and extension. A zone is herein defined as an area that can be characterized by specific geographic information in the form of latitude, longitude and extension, such as radius.

Also, a location server for zone evaluation is presented. This location server may be called Zone Evaluation Location Server (ZELS).

By using ZELS operators is given a flexible and powerful way of providing charging and emergency services in addition to potentially revenue-generating commercial services, such as information services, games, friend finder and fleet/resource management.

From the prior art it is known that geographical positions and areas in general, providing the same tariff regardless of cell planning or serving base stations are not constant over time. Due to changes and updates of the cell planning and service base stations, the geographical positions and area providing the same tariff are changed over time.

For service of location based systems, the task of zone evaluation may be aimed at enabling customized services in a variety of different fields. Such customized services may be provided for users calling within predefined specific geographical areas that are truly geographical. These truly geographical areas are cell-independent and are hence not changed upon updates in cell planning. For the same reason the services that can be provided are also cell-independent.

For the specific service of location based charging, the task of zone evaluation can be aimed at enabling customized services such as discounted rates for users calling within predefined specific true geographical areas.

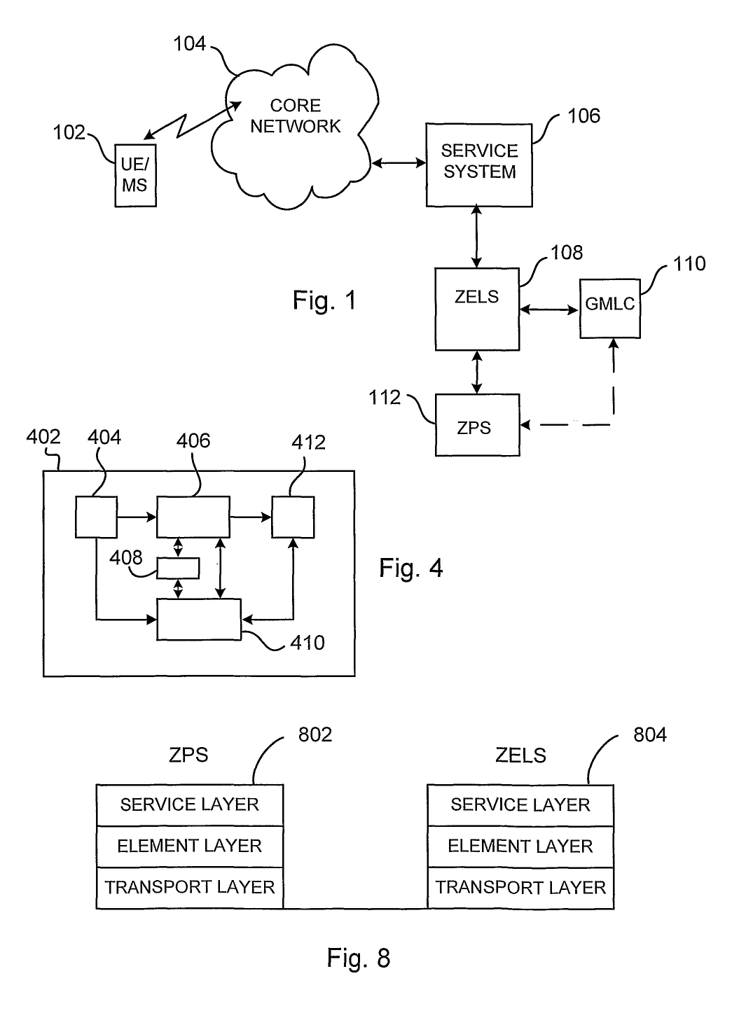

With reference to FIG. 1 presenting at least parts of an overall basic communication system, at few embodiments of present invention will be described further. W

A User Equipment (UE) 102 can be connected via a Core Network 104 to a service system 106, such as charging system. The service system 106 is also connected to a Zone Evaluation Location Server (ZELS) 108. This location server 108 is further connected to a Zone Positioning System (ZPS) 112. The ZELS server 108 as well as the ZPS may in addition be connected to a Gateway Mobile Location Server (GMLS) 110.

In short, the ZELS server 108 is typically adapted to store zone information for subscribers' customized services. For each subscriber one or more geographical zones may be defined. Information about these zones comprises the true geographical position of the zone, for instance of its center, and the size of the zone. When a subscriber makes a call this information may be provided to the ZELS server such that the ZELS server can determine whether the geographical position of one of the subscriber's zones matches the location of the subscriber, in terms of that the user is found to be located within the matching zone.

If a certain subscriber is determined to be located within a zone which is associated with the subscriber, said subscriber is permitted to benefit from the special service that is associated with the zone, such as a low call tariff, high band width, low fare for on-demand video services, etc.

A subscriber or service user having with a zone at her residence can thus benefit from a call tariff, when the subscriber or service user is located inside the geographical zone at her residence.

An operator or a subscriber can define one or more frequently visited zones to be evaluated when making a call. The zone evaluation location server (ZELS), that secures storage of defined zones, is responsible for the evaluation of zones, and provides the calculated results to the service system.

Upon service setup, the location server for zone evaluation may obtain user location data derived from the network. The location server thereafter determines whether the user's location as estimated at least partly overlaps at least one geographical area of a set of predefined geographical areas of the user. If the location server determines that the estimated location of the user is overlapping one of the predefined geographical areas, it delivers information as a response to the service system.

This determination is performed without any regard to the serving cell or base station of the user's mobile telephone. As earlier mentioned, the predefined areas, also called zones, are purely geographical.

In the following the location server ZELS will be described in more detail.

ZELS may be a node that is designed to interact with an arbitrary service system to provide zone evaluation information to be used as the base for, for example, rating a service based on current user location.

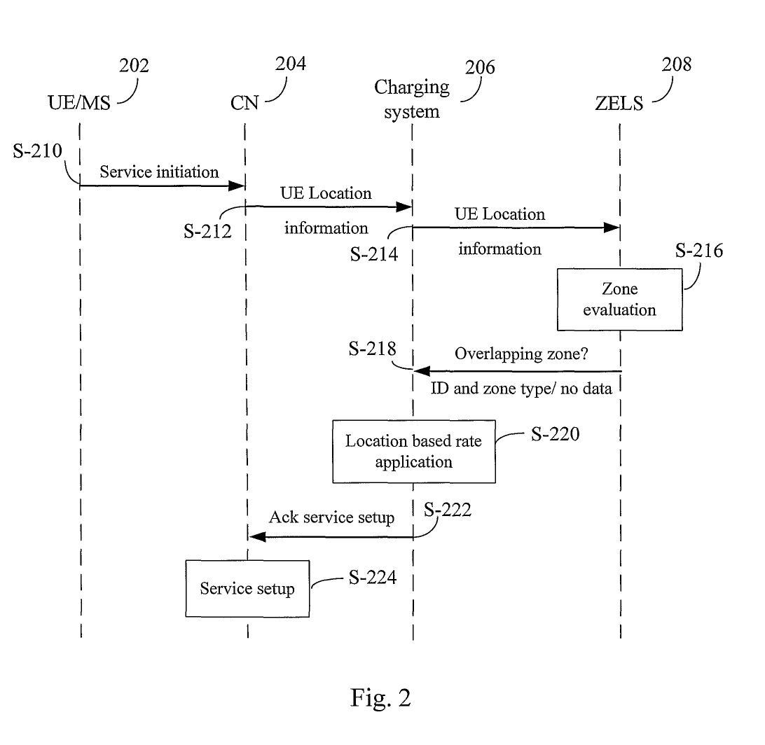

In the following it will be described a signal flow as depicted in FIG. 2, for a service setup with zone evaluation according to some embodiments of the present invention. The charging system as presented in FIG. 2, serves merely as a one example of a service system. Reference is hence given to FIG. 2.

The service setup according to some embodiments may start at the User Equipment (UE) 202 by sending a service initiation message S-210 to the Core Network (CN) 204. The CN may provide the location information for the UE. In step S-212 location information may be sent from the CN 204 to the charging system 206, in this example. The charging system 206 may use a tariff based on zones. In order to determine the appropriate tariff, the charging system 206 may send UE location information to a zone evaluation location server (ZELS) 208, in which a zone evaluation is performed S-216.

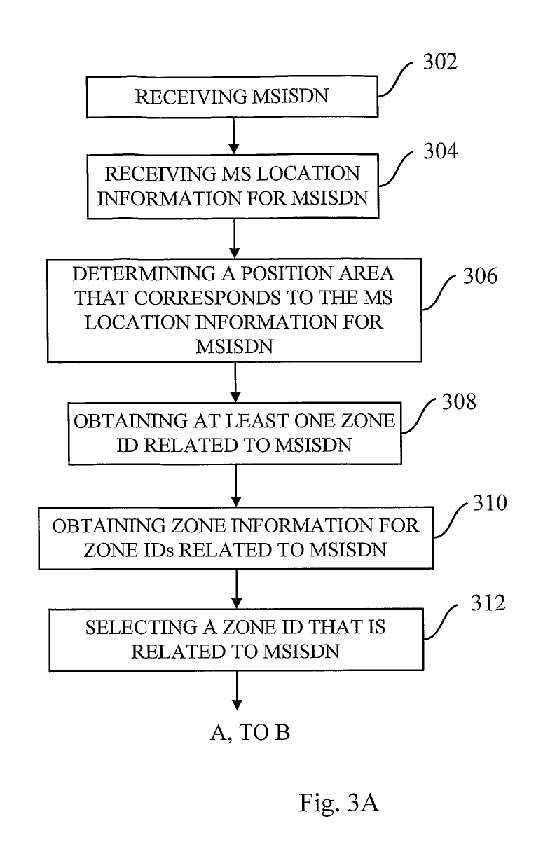

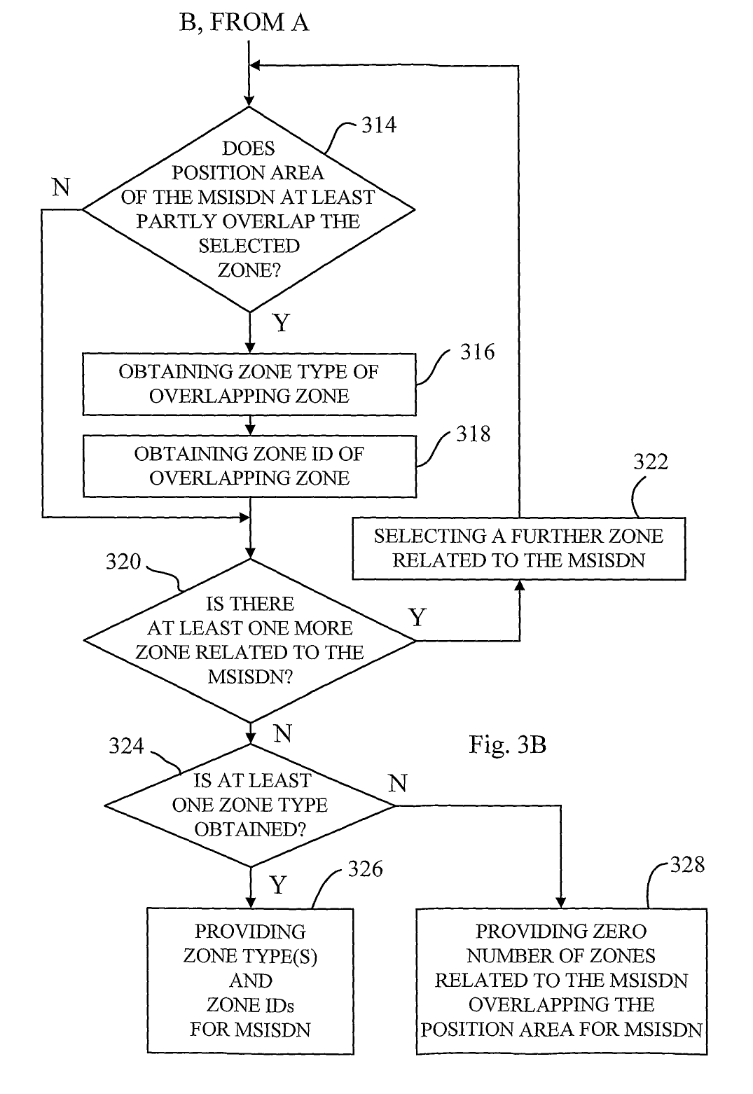

With reference to FIGS. 3A and 3B, presenting a flowchart illustrating method steps of location evaluation, location evaluation according to at least some embodiments of the present invention will now be described. Reference will also be given to the location server for evaluation as schematically presented in FIG. 4.

The location server 402 may comprise an obtaining unit 404 connected to a processor 406. The processor 406 may be connected to a memory unit 408 and to a sending unit 412. Moreover, a control unit 410 controlling the function of the receiving unit 404, the processor 406, the memory unit 408 and the sending unit 412 may also be comprised in the location server 402. The function of each of these units will be described in connection to the description of the method steps in FIGS. 3A and 3B.

The method of zone evaluation may start with the step of receiving a Mobile Station International Subscriber Directory Number (MSISDN) of a Mobile Station (MS) or a User Equipment (UE) 202, in step 302. Next, mobile station (MS) location information for the MSISDN may be received in step 304. The information as received in step 302 and in step 304 may be received by the obtaining 404 from the charging system 206, being one example of the service system 106.

The subsequent step may be the step of determining a position area that corresponds to the MS's or UE's location information for the MSISDN, step 306. The position area is herein defined as the area that corresponds to the uncertainty of the location information as received in step 304.

Step 306 may be performed by the processor 406 under the control of the control unit 410.

It can be mentioned that the positions area is typically smaller than the size of a normal cell.

The following step is the step of obtaining at least one zone identity that is related to the MSISDN, step 308. This step may be performed by the processor 406 in connection with the memory unit 408 under the control of the control unit 410.

It should be mentioned that each zone can be identified by its zone identity number.

The step to follow may be the step of obtaining zone information for the zone identities that are related to the MSISDN, step 310. In this step information about the size may be obtained. This step may again be carried out by the processor 406 in connection to the memory unit 408, while the control unit 410 may control this step.

The next step may then be the step of selecting a zone ID that is related to the MSISDN, in step 312. This step may again be carried out by the processor 406 in connection to the memory unit 408, under the control of the control unit 410.

It can now be determined in step 314 whether the position area of the MSISDN at least partly overlaps the selected zone, or not. This step may be performed by the processor 406, under the control of the control unit 410.

In the case there is an overlap determined in step 314, the following step is step 316, obtaining the zone type of the overlapping zone. With assistance of the memory unit 408, this step may be executed by the processor 406 under the control of the control unit 410.

The are a large number of possible zone types that can be used within embodiments of the present invention. For instance, the zone may be a private zone that herein is defined as a zone type that the user of the MS or UE can define and is applicable only to the MS/UE, based on the MSISDN number. The zone type may alternatively be a shared zone, or a public zone, to mention a few other zone types only.

It can be mentioned that the International Mobile Subscriber Identity (IMSI) number may be used instead of the MSISDN, or possible in addition to the MSISDN. Although the MSISDN is a subscription number and the IMSI a device number, they can reflect the same identity.

The subsequent step of the method to evaluate location information, may be the step of obtaining the zone ID of the overlapping zone, in step 318.

The processor 406 of the location server 402 may perform step 318, in connection with the memory unit 408.

In the following step it is determined whether the are additional zones related to the MSISDN which should be evaluated in terms of the location of the MSISDN. Step 320 consequently comprises determining whether there is at least one more zone related to the MSISDN, or not.

In the case it is determined that there is at least one more zone related to the MSISDN in step 320, the subsequent step of the processor 406 may the step of selecting a further zone related to the MSISDN, in step 322. Similar to a number of other steps, this step may be performed by the processor 406, under supervision of the control unit 410.

Having selected a further zone related to the MSISDN in step 322, the processor now determines whether the position area of the MSISDN at least partly overlaps the selected zone, or not, in step 314, as previously described.

However, in the case it is determined by the processor unit 406 that there are no more zones related to the MSISDN in step 320, the following step if step 324, determining whether at least one zone type is obtained or not.

The information that may be provided to the zone provisioning system depends on the result in step 324.

In the case at least one zone type is obtained in step 324, i.e. at least one position area and zone overlap is detected for the MSISDN, the step of providing the zone type(s) and zone IDs for the MSISDN can be performed. This step is typically performed by the sending unit 412 in connection with the processor 406 under control of the control unit 410.

Having obtained a zone type(s) in step 324, the zone type and the zone IDs may be provided for the MSISDN. This is also illustrated in message S-218 in FIG. 2.

In case no zone type(s) are obtained in step 324, the following step is the step of providing zero number of zones related to the MSISDN overlapping the position area for the MSISDN, in step 328. This response of zero number of zones related to the MSISDN overlapping the position area for the MSISDN is also illustrated in FIG. 2 as the message S-218 from the ZELS 208 to the charging system 206, according to this example. This step may be performed by the sending unit 412 in connection with the processor 406 under control of the control unit 410.

As earlier mentioned in connection with step 316 the zone type may be private. The zone may alternatively be shared, with means that the zone is a zone that is related and applicable to a plurality of MS, in contrast to the private zone that is related and applicable to one MS only. Another type is the public zone, which is related to all subscribers of the service in point. A public zone may be a well-defined zone in terms of size, shape and validity, just as the private zone can be characterised. Shared zones, public zones as well as private zones, and zones in general will be described in closer detail below.

In the case more types of applicable zones that relate to the MSISDN, exist, further loops of method steps step 314 to step 322, as illustrated in FIG. 3B may have to be performed to evaluate the location of the MSISDN with regard to the applicable zones.

Returning to the signal flow in FIG. 2, the charging system 206 may now have received any response from the location server 208, after which the charging system 206 now can perform location based rate application in message S-220. Based on the received zone identities a location based rate application can thus be performed.

The charging system 206 may then send an acknowledgement service setup message, S-222 to the core network (CN) 204 to enable the CN setting up of the service, S-224 which service was initiated in message S-210 as illustrated in FIG. 2.

The location server for zone evaluation (ZELS) may thus deliver the zone evaluation result to the charging system by including information what type(s) of zone(s) the MS/UE location estimate matches. Based on this information, prior to service setup, the charging system may define the rate of the call according to the current desired zone based rating strategy following the type of one or more overlapping zone(s).

If rating does not have to be made prior to setting up the service, ZELS may instead simply store the evaluation result in a Call Data Record (CDR) for later analysis, or the charging system can produce a CDR, based on the response from ZELS.

To perform the zone evaluation for a call, ZELS may use information about the current location of the user at call setup and match it with its stored zones. The current location can be provided by the core network and relayed by the charging system.

The actual kind of location information depends on the specific network being used and the service available. The Location Information (LI) that can be provided can be:
Cell Global Identity (CGI) for Global System for Mobile communications (GSM) networks
CGI and Timing Advance (TA) for GSM networks with TA available
Service Area Identity (SAI) for Wideband Code Division Multiple Access (WCDMA) networks

In the future LI derived by more precise methods such as Global Positioning Systems (GPS), Uplink Time Difference Of Arrival (UTDOA) or other methods, could alternatively be used.

As explained above, the location information may be forwarded to ZELS prior to call setup. In addition, this location information can be forwarded together with the Mobile Station International Subscriber Directory Number (MSISDN) number of the calling party, i.e. the A number, of the called party, i.e. the B number, or both.

Sending location information on a service setup basis may enable ZELS to perform real time evaluations, based on real time location information, for any service initiation made in the network where location information can be delivered.

In the case the B-number of a call is delivered together with the A-number, ZELS may also be arranged to perform a distance based evaluation, allowing the charging system to rate accordingly based on the distance between the A- and B number using the service.

The geography-based zones will now be described in some more detail. One of the main features of ZELS is its geography-based zones.

Geography-based zones are actual geographic, or rather spatial, objects. Their properties can only be altered on purpose. Cells that are serving users within such a zone can be moved, deleted, added, renamed or changed in any way without affecting the zone properties. The LI given to ZELS during the use of a service, such as a phone call, will be evaluated by its geographical location and not by a name or by an ID of the serving cell or by other using similar labels. The location is then matched to the zone's geographical location. If the two areas at least partly overlap, i.e. partly or fully, the match is considered to be positive.

There are practically no restrictions on the types of zones, which can be supported by a location server according to some embodiments of the present invention. However, in order to illustrate a few zone types, a private zone, a shared zone, and a public zone will be described.

Private zones are related to a specific MSISDN and for this reason no other user can benefit from this zone. This could be a user's home or other private area, and only if a specific MSISDN calls from it, a specific rate would be applied.

According to some alternative embodiments other MSISDN making a call from here would not be considered or even evaluated towards this private zone.

When defining a person's home as a private zone, alternatives to fixed-line installations may be provided. Each subscriber may have defined several private zones, for instance at home and at the summerhouse. Using a plurality of private zones rings an advantage in relation to fixed-line installations where two subscriptions have to be used, since the private zones may be related to the same MSISDN and therefore the same subscription. In terms of charging, the same tariff may be used for calls originating at either the home or the simmer house, independent of the different zone IDs. Alternatively, different charging may of course also be based on the respective zone ID.

Shared zones are related to a group of MSISDNs and users belonging to this group can benefit from e.g. low call rates when calling from inside it. An example of a shared zone would be an office where all employees belong to a shared zone covering the company premises and hence are given lower rates when using their mobile phones at the office.

Non-employees would not be part of the shared zone and therefore would not be able to benefit from any specific tariff agreed upon between the company and the operator.

Shared zones could of course also be a home, and the group of MSISDNS would then typically be a family inhabiting that home. Using the same methodology, guests would not benefit from the service when calling from the family's home.

Another example of alternatives to fixed-line installations and charging may be corporate subscription. A company may have defined a shared zone around the company's premises. In the case of Ericsson, one shared zone may be defined as the entire Kista office. Such a shared zone could comprise all employees working at the Ericsson office. Whenever an employee is calling from this zone, Ericsson may be charged according to a special tariff. If, however, an employee is leaving the shared zone and travels home, for instance, and calls from his/her home, the call could be charged differently.

There are most certainly many possibilities for the set up of a shared zone, but only a few are mentioned here.

Public zones are all subscribers, and not related to any specific MSISDN. The only prerequisite would be to be part of the ZELS service, that is stored as a subscriber in the ZELS itself, either by subscription or other means. A public zone may be a stadium, a famous landmark, or any area where the operator may want to promote calls by offering lower rates. Agreements between the operator and franchises such as hamburger restaurants and coffee bars could be set up for mutual benefit. Public zones could also be used as regional boundaries such as cities, states, or provinces. For obvious reasons the list can be made much longer.

Zones can have any sizes and shapes and overlap each other. They may have 2 or more dimensions in the Euclidean space. An example of a third Euclidean dimension is the altitude. In addition they may have a time dimension providing fully dynamic zones variable in time, defining for instance expiration times or duration intervals. A zone may exist or have a first shape between certain hours, while between other hours the zone may not exist or may have a second shape that is different from the first shape.

Zone is herein defined as an area that can be characterized by specific geographic information in the form of latitude, longitude and extension, such as a radius.

A user can hit several zones of the same or different types given his/her current location estimate. For this reason a priority mechanism is disclosed to minimize the number of zone types delivered in the zone evaluation result. Priorities may be set per zone, and/or per type to make up a priority tree to use when several zones are covering the same area.

An example may be a large public zone covering a downtown area, where several offices, that may be shared zones, and residential homes, that may be private zones, are located. In this case, priorities within the types can help to define what rate to use in such a multi-zone overlap situation.

If the following priorities were set as firstly private, secondly shared and thirdly public, it would imply that e.g. if a user is calling from his home, he/she would get the home tariff even if the home is located within a public zone area.

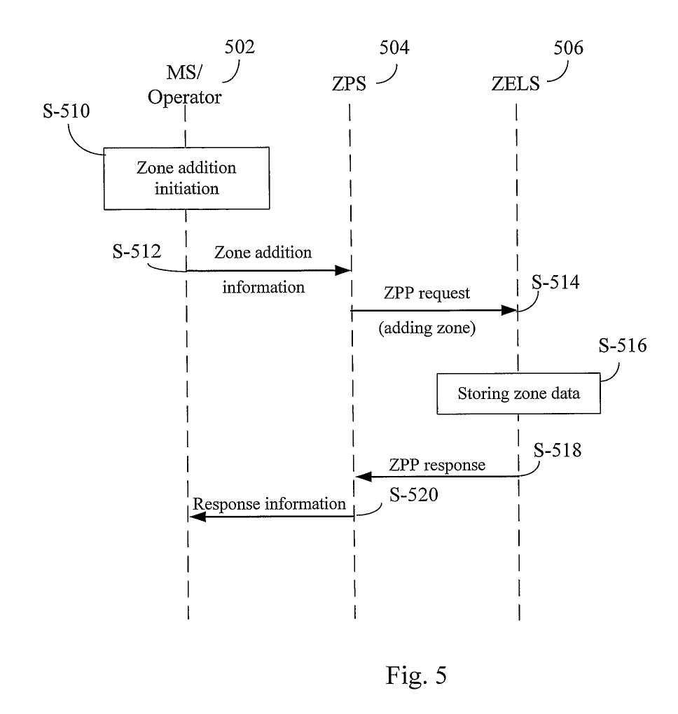

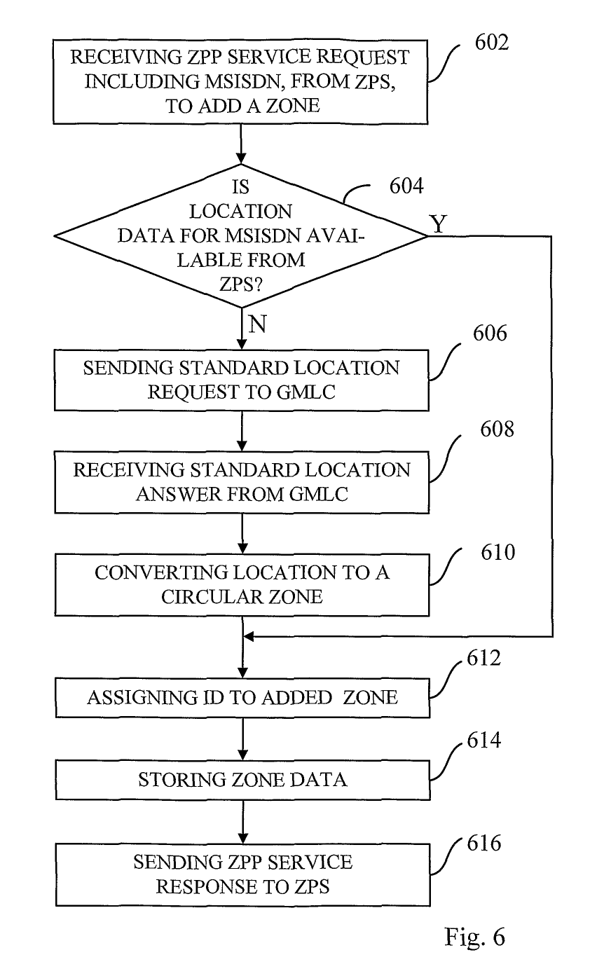

With reference to FIGS. 5 and 6, presenting a signal flow and a flowchart of zone addition, respectively, some embodiments of the present invention will now be described.

Either a MS/UE or an operator 502 may initiate the method. As one example in FIG. 5, zone addition initiation can be performed by said MS/UE 502 or by the operator 502. Next, the MS/UE or operator 502 provides zone addition information to the zone provisioning system (ZPS) 504.

ZPS may thus be reachable by both the user and the operator. End user access may be given via several interfaces such as web based map applications, Interactive Voice Response (IVR), Wireless Application Protocol (WAP), Short Messaging Service (SMS), or Unstructured Supplementary Service Data (USSD). Also, calling the operator's customer service may help the user to set up his own zone based on where the user is calling from.

ZPS has a large number of possibilities and shall here be seen as an application capable of receiving information on zones and users of ZELS service. It may be the responsibility of ZPS to provide the end user- and operator interfaces and then interact with ZELS using a zone provisioning protocol (ZPP).

Now, the ZPS 504 may send a ZPP request to the location server for zone evaluation or Zone Evaluation Location Server (ZELS) 506, to add a zone.

Reference will also be made to FIG. 6, presenting a flowchart of method steps for processing of a service request.

In step 602, the ZELS 506 may receive a ZPP service request including the MSISDN from the ZPS 504 to add a zone.

Having performed step 602, the next step is step 604 to determine whether location data for MSISDN is available from the ZPS, or not.

In the case it is determined in step 604 that location data for the MS is available from ZPS, the following step may be the step of assigning a zone identity (ID) to the added zone in step 612. The following step may be storing zone data in step 614, after which a ZPP service response may be sent to the ZPS 504, in step 616.

Sending of the ZPP response is also illustrated in FIG. 5 by message S-518. The ZPS 504 may subsequently provide response information to the MS or the operator, which ever was initiating the service request in message S-510.

If it is determined that location data for the MSISDN is not available from the ZPS, at step 604, ZELS may perform the step of sending a Mobile Location Protocol (MLP) Standard Location Immediate Request (SUR) to a Gateway Mobile Location Centre (GMLC), step 606.

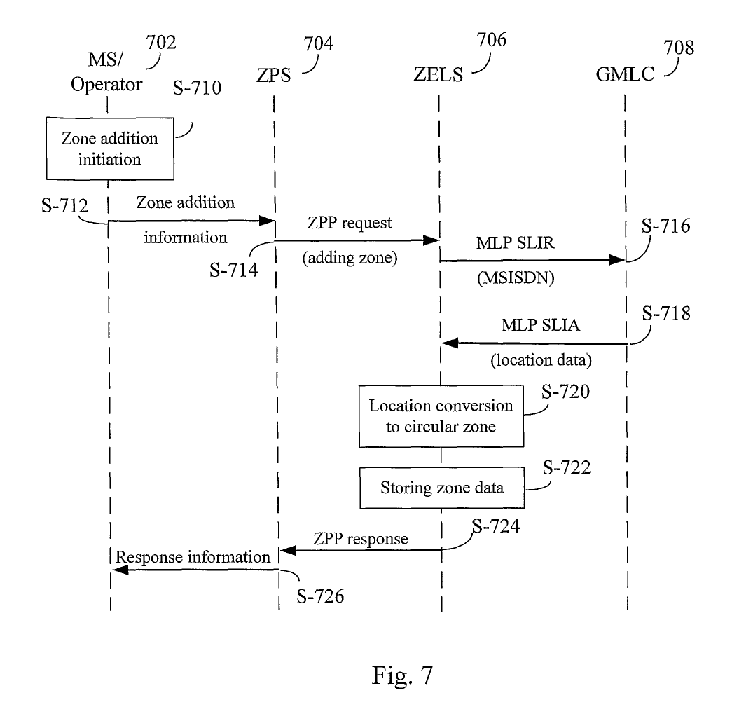

It should be mentioned that these steps are also presented in FIG. 7 illustrating a signal flow for processing a service request of adding a zone. The similarity of FIGS. 5 and 7 can easily be seen. Messages S-712 and S-714 correspond to messages S-510 and S-512, respectively.

Thus step 606 as presented in FIG. 6 corresponds to message S-716 from ZELS 706 to the GMLC 708. The Gateway Mobile Location Centre (GMLC) 708 thus provides location information and sends a message Mobile Location Protocol (MLP) Standard Location Immediate Answer (SLIA) comprising location information for the MSISDN to the location server 706.

The method as presented in FIG. 6 thus comprises step 608, receiving Standard Location Immediate Answer (SLIA) from GMLC 708. Having received the location data, the ZELS may perform location conversion to a circular zone in step 610, and as presented in message S-720 in FIG. 7.

When a zone is added or created, the shape, size and location of it are thus defined in ZELS during creation of the zone. Typically, a center point represented as latitude and longitude, together with a radius defines a circular zone area. However, elliptic and polygon shaped zones, as a sequence of space or time coordinates, may be used to define any other type of area or n-dimensional space.

The following steps are then the step of storing the zone data, step 614, and the step of sending ZPP service response to ZPS in step 616. These steps are also presented as messages S-724 and S-726 of FIG. 7.

Any shape of the zones may be used. However, for simplicity the location data may be converted to a circular zone in step 610.

According to at least some embodiments of the present invention, the zones may be provisioned in the ZELS node by a ZELS-external Zone Provisioning System (ZPS) using a specific eXtensible Markup Language (XML)/http based Zone Provisioning Protocol (ZPP). This protocol is provided in order to enable management and administration of zones in ZELS.

FIG. 8 presents a layered structure of the zone provisioning protocol, ZPP, according to an example of the present invention, between ZPS 802 and a ZELS node 804. As shown, the lowest layer is a transport layer in which a transport protocol may define how XML content is to be transported.

The second layer is an element layer, which defines common elements used in the highest layer, the service layer. It is the service layer that defines the actual services that may be offered by ZPP.

ZPP may provide a format for how to define users, zones, and priorities. It can facilitate the assignment of zone IDs and can enable provisioning operations such as adding/deleting/modifying a zone, or adding/deleting users, to mention some of a large variety of possible operations or services.

A few examples of service requests and service message requests will now be presented.

“Add zone” is indeed a service used for defining a zone.

This service comprises the following messages:
Add a private zone for a subscriber, when the location is available
Add a private zone for a subscriber, including positioning of the user
Add a shared zone
Add a shared zone with a list of subscribers
Add a public zone

“Get zone” is another service used for getting zone definition.

This service comprises the following messages:
Get a private zone for a subscriber
Get a shared zone
Get a public zone
Get all zones for a subscriber
Get all private zones for a subscriber
Get all shared zones for a subscriber
Get all shared zone
Get all public zone

“Modify zone” is another service used for modifying a zone.

This service comprises the following messages:
Modify a private zone
Modify a private zone to the current location
Modify a shared zone
Modify a public zone

“Remove zone” is yet another service used for removing a zone.

This service comprises the following messages:
Remove a private zone
Remove a shared zone
Remove a public zone
Remove all zones for a subscriber

“Associate subscriber” is yet anther service used for adding a subscriber to an existing shared zone.

This service comprises the following message:

Associate a subscriber to a shared zone

“Dis-associate subscriber” is a service used for removing a subscriber from a shared zone.

This service consists of the following messages:

Dis-associate a subscriber from a shared zone

“Friends” is a yet a service used for providing information which zones are friends with which. A phone call between parties residing in zones that are friends may be charged according to a special tariff, for instance, for free. One example may be the case in which phone calls between two Ericsson offices are free; another the case in which a phone call between a person's residence and the person's summer house, where cell phones may be the single way to make a voice call, may be charged according to a lower tariff. This could apply to everyone being there.

In the processing of a “friends” service request, an analysis of both the A-number and the B-number would be needed in order to be able to grant the request or not.

“Time limit” is still yet another service for specifying that a zone may be valid a certain time duration only or, for instance, on a regular basis every Tuesday evening between 7:00 and 9:00 PM.

In the following will be described a method for provisioning services and operations enabling management of a subscriber-related zone database, according to some embodiment of the present invention.

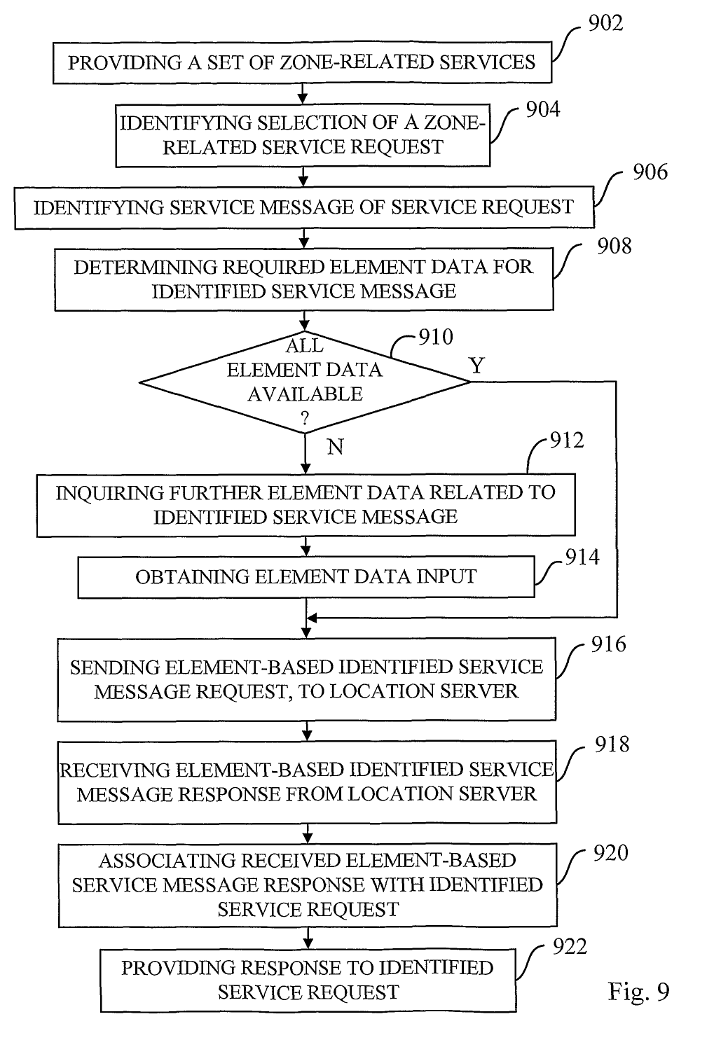

This method may have large similarities with the Zone Provisioning Protocol (ZPP). Reference will however be given to FIG. 9, presenting method steps of the aforementioned method.

The method for provisioning services or operations enabling management of the subscriber-related zone database, may start with step 902, providing a set of zone-related services. A set of services may thus be provided to a user or an operator. This step may be performed by the ZPS 504, 704.

Next step may be identifying a selection of a zone-related service request, step 904. This step may also be performed by the ZPS 504, 704. The user or an operator may make a selection, after which the selection of service request thus can be identified.

In the following, the service message of the service request may be identified in step 906. The type of service as well as the service message for a following request are thus identified. Step 906 may likewise be performed by ZPS 504, 704.

In order to continue processing the service message request, it is determined in step 908 the required element data. In step 910 it is consequently determined whether all element data is available or not. These two steps can also be performed by ZPS 504, 704.

In the case the element data is at least partly not available, the next step may be the step of inquiring further element data related to the identified service message, in step 912, which can be performed by the ZPS.

In order to successfully proceed with the method, the next step may be the step of obtaining element data input in step 914, by the ZPS 504, 704.

A user or an operator may thus add additional required data. Since some service message requests may require more input in the form of element data than others, this step has its relevance.

Having obtained further data input, the following step may be the step of sending an element-based identified service message request to the location server 506, 706, in step 916. This step may thus be performed by the ZPS 504, 704. The location server 506, 706 may be the location server for processing of a zone-related service request (ZELS).

Also, if it is determined by the ZPS in step 910 that all element data is available, no further data element input may be required, for which reason the following step may be the step 916 of sending an element-based identified service message request by the ZPS 504, 704 to the location server 506, 706, as described above.

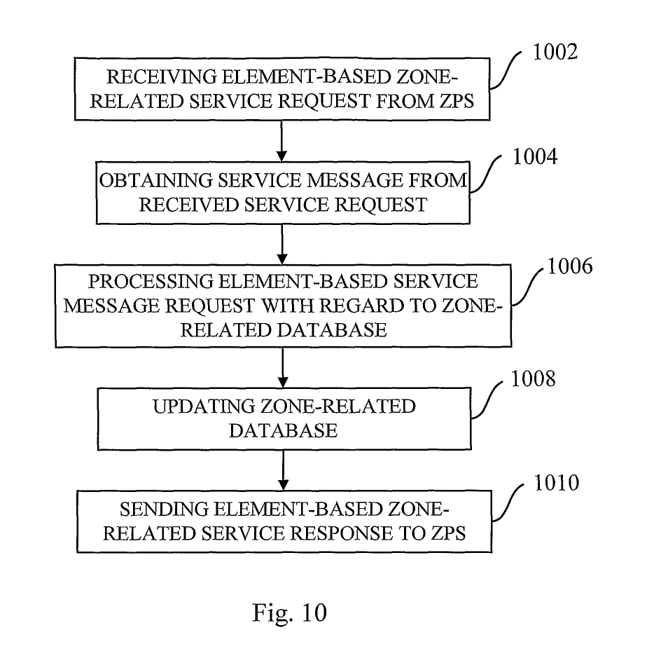

The proceeding steps of this method depend on method steps that may be performed by a location server 506, 706. For this reason, a flowchart is now presented illustrating method steps of a method of processing a zone-related service request while referring to FIG. 10.

Thus, in step 1002 an element-based zone-related service request may be received by the location server ZELS from the zone provisioning system (ZPS).

Having received this service by the location server 506, 706, the service message may be obtained from the received service request in step 1004.

The service message request is now processed by the location server 506, 706 in the proceeding step. Hence, processing of element-based service message request with regard to zone-related database may now be performed by the location server 506, 706 in step 1006.

Having processed this service message request, updating of the zone-related database may be performed by the location server 506, 706 in step 1008.

In order to provide the answer to the processing of the service request, the steps of sending an element-based zone-related service response to the ZPS 504, 704 is thus performed by the location server 506, 706 in step 1010.

A response is thus sent to the ZPS 504, 704, from where the service message request was initially sent in step 916.

The following step of the method to provision services related to a subscriber-related zone database may thus be step 918, receiving an element-based identified service message response from the location server 506, 706 by the Zone Provisioning System PS 504, 704.

In a subsequent step, step 920, associating the received element-based service message response with identified service request, may be performed. The element-based response may here be converted to better fit the user or the operator 502, 702, being the initiator of the service request.

At the end of this method, a response to the identified service request can be provided, in step 922. This is typically provided to the user or the operator 502 by the ZPS 504, 704.

Leaving the description of the method steps, it can be mentioned that in addition to provisioning of data to users on demand, zones and subscribers may also be loaded in bulk via importing mechanisms in ZELS and/or ZPS.

If ZPS has no access to geographical data, ZELS or ZPS can make a call to a GMLC and request the current location of the user. One example may be a user calling customer care requesting a zone but without being able to provide his/her current location. This location can then be used to define the zone.

The accuracy of the obtained position area or location will be dependent on the accuracy of the positioning method available in the operator's network and the user's handset. Any thing from the size of the serving cell to AGPS-generated locations within some meters accuracy can be obtained.

Conversion from the returned format into a more suitable internal format, such as circles for fast spatial calculations and minimum storage consumption, may be made by ZELS.

When using a GMLC to do real time user positioning to obtain the zone information, ZELS/ZPS may also position the user several times and use averaging algorithms to refine the estimate. This may be especially valuable in case low accuracy methods are used to obtain the MS/UE position. Restrictions in maximum and minimum zone sizes can also be applied.

It is emphasized that the present invention can be varied in many ways, of which the alternative embodiments as presented are just a few examples. These different embodiments are hence non-limiting examples. The scope of the present invention, however, is only limited by the subsequently following claims.

According to some embodiments of the present invention, the exact order of the steps of the method of evaluating the location of a user equipment (UE) in relation to at least one geographical zone related to the UE, of processing of zone-related service requests, and of provisioning of services related to a subscriber-related zone database, can be changed and some steps can even be deleted without deferring from the scope of protection of the present invention.

At least some of the embodiments of the present invention come with a number of advantages of which a few are:

One advantage of a system comprising location servers as described above is that it is easily scalable enabling operation in connection with huge subscriber bases. Evaluation of the location of a user in terms of predefined geographical areas such as zones, is hereby brought out from conventional service systems.

One advantage of using ZELS for location based charging is its cell network structure independence. In the case the ZELS-internal cell database is kept up to date, it will evaluate any cell or SAI related call and match it to zones that have no correlation to the current cell structure. The internal database may typically be kept up to date by automated imports of cell data given from the operator's Operating Support System (OSS) as done today in many Mobile Positioning Systems (MPS) solutions.

As cells are added, removed, split or changed, ZELS may continue to serve the service system with accurate location based information, the reason being the geographical, or rather spatial, definition of zones that is the foundation of the system.

A zone is created as a geographical area that is constant and the definition of which remains the same unless it is deleted or modified on purpose. It is irrelevant what cell or SAI is currently being used when a call is set up. The cell, TA arc or SAI corresponding to the MS/UE current position estimate is merely seen as an anonymous spatial area to be matched with the area defined by the zone. This is a great advantage to the cell mapping or LA approach.

Another advantage is the resolution in a ZELS based approach can be made far higher than if using Location Areas. In an area with huge macro cells, the actual areas from which a user can benefit from lower tariffs might of course be larger than in a pico cell environment, but this “drawback” is the same whatever approach is used.

ZELS' approach of responding directly with a provided result to the calling party can be superior to most LoCation Service (LCS) client based spatial trigger solution available where the evaluation and notification is separated into separate systems and separate carriers. The latency of ZELS may typically be around 50-80 milliseconds to receive location information, provide a complete evaluation of the call, and respond to the calling party, e.g. the service system.

With the layout of different zone types, ZELS also has a possibility to bundle many zones into one tariff, and even exclude zones in a multiple zone hit using priority mechanisms, which can reduce payload and stress on the charging system. Trigger areas used in today's spatial trigger solutions are typically built as separate entities.

By using the ZELS approach, the zone evaluation is not integrated with any specific service system. This enables the operator to expand zone-based services, while keeping the service systems intact and enclosed. The operator may expand ZELS usage with disaster alerting functionality, commercial spatial trigger based functionality, location based advertisement etc.

The following abbreviations have been used in the document and are hereby included to facilitate the reading of the document.

### AGPS Assisted Global Positioning System

CAMEL Customized Applications for Mobile networks Enhanced Logic

### CAP CAMEL Application Part

### CGI Cell Global Identity

### CGI-TA Cell Global Identity—Timing Advance

### ECGI Enhanced Cell Global Identity

### GMPC Gateway Mobile Positioning Centre

### GMLC Gateway Mobile Location Centre

GSM Global System for Mobile communication
gsmSCF GSM Service Control Function
gsmSSF GSM Service Switching Function

### HLR Home Location Register

### HTTP Hyper Text Transfer Protocol

### IMSI International Mobile Subscriber Identity

### ISDN Integrated Subscriber Directory Number

### IVR Interactive Voice Response

### LA Location Area

### LCS LoCation Service

### MLP Mobile Location Protocol

### MS/UE Mobile Station/User Equipment

### MSC Mobile Switching Centre

### MSISDN Mobile Station International ISDN Number

### OSS Operations Support System

### SAI Service Area Identity

### SLIA Standard Location Immediate Answer

SLIR Standard Location immediate Request

### SMS Short Message Service

### USSD Unstructured Supplementary Service Data

### UTDOA Uplink Time Difference of Arrival

### VLR Visitor Location Register

WAP Wireless Application protocol

### WCDMA Wideband Code Division Multiple Access

XML eXtensible Markup Language

### ZELS Zone Evaluation Location Server

### ZPP Zone Provisioning Protocol

ZPS Zone Provisioning System

1-27. (canceled)

28. A method of evaluating the location of a User Equipment (UE) in relation to at least one geographical zone related to the UE, in a service enabling communication system, said method comprising:
obtaining location information about a location of the UE,
obtaining zone information about the at least one geographical zone,
evaluating the obtained location information in relation to the at least one geographical zone, by determining whether the location of the UE at least partly overlaps the at least one geographical zone, and
providing a location evaluation response that is dependent on said determining.

29. The method according to claim 28, further comprising obtaining a subscriber identity number for the UE, wherein obtaining said zone information comprises obtaining zone information for the subscriber identity number, and wherein evaluating the obtained zone information comprises evaluating the obtained zone information for the subscriber identity number, by determining whether the location of the UE at least partly overlaps the at least one geographical zone for the subscriber identity number.

30. The method according to claim 29, wherein the subscriber identity number is a Mobile Station International Subscriber Directory Number (MSISDN).

31. The method according to claim 28, wherein providing a location evaluation response comprises providing a zone type of a geographical zone that is overlapping the location of the UE.

32. The method according to claim 28, wherein providing a location evaluation response comprises providing an identity of a geographical zone that is overlapping the location of the UE.

33. The method according to claim 28, wherein the location of the UE comprises a position area of the UE.

34. The method according to claim 28, wherein the at least one geographical zone comprises at least one cell-independent geographical zone.

35. A method of processing zone-related service requests, said method comprising:
obtaining a zone-related service request from a zone provisioning system,
processing said zone-related service request in relation to a subscriber-related zone database,
providing a zone-related service response to the zone provisioning system, and
enabling management of the subscriber-related zone database.

36. The method according to claim 35, further comprising sending a location information request to a location node, obtaining a location information response from the location node, and wherein said processing comprises processing said zone-related service request in relation to the obtained location information response.

37. The method according to claim 36, wherein the location node comprises a Gateway Mobile Location Centre (GMLC).

38. The method according to claim 35, wherein the zone-related service request and the zone-related service response comprise a service message request and a service message response, respectively.

39. The method according to claim 35, wherein a zone refers to a cell-independent geographical zone.

40. A location server for evaluating the location of a user equipment (UE) in relation to at least one cell-independent geographical zone related to the UE, wherein the location server is configured to connect to a service enabling communication system, the location server comprising:
an obtaining unit configured to obtain location information about a location of the UE,
an evaluation unit configured to evaluate the obtained location information in relation to the at least one cell-independent geographical zone related to the UE, and
a sending unit configured to respond to the obtained location information.

41. The location server according to claim 40, further comprising a memory unit comprising a subscriber-related database of cell-independent geographical zones.

42. The location server according to claim 41, wherein the memory unit comprises at least one cell-independent geographical zone for a subscriber identity number related to the UE, and wherein the evaluation unit is configured to evaluate the obtained location information in relation to the at least one cell-independent geographical zone for the subscriber identity number related to the UE.

43. The location server according to claim 40, wherein the sending unit is configured to provide a zone type of a cell-independent geographical zone that is overlapping the location of the UE.

44. The location server according to claim 40, wherein the sending unit is configured to provide a zone identity of a cell-independent geographical zone that is overlapping the location of the UE.

45. The location server according to claim 40, wherein the location of the UE comprises a position area of the UE.

46. The location server according to claim 40, wherein the obtaining unit is configured to receive a zone-related service request that is related to a geographical zone, wherein the evaluation unit is configured to process the zone-related service request in relation to a subscriber-related zone database, and wherein the sending unit is configured to respond to the obtained service request.

47. A location server for processing a zone-related service request, wherein the location server is configured to connect to a service enabling communication system, the location server comprising:
an obtaining unit configured to receive the zone-related service request, the zone-related service request related to a geographical zone,
a processor configured to process said zone-related service request in relation to a subscriber-related zone database, and
a sending unit configured to respond to the obtained service request,
enabling management of the subscriber-related zone database.

48. The location server according to claim 47, further comprising a memory unit that comprises the subscriber-related zone database.

49. The location server according to claim 47, wherein a zone refers to a cell-independent geographical zone.

50. The location server according to claim 47, wherein the obtaining unit is configured to obtain location information about a location of the UE, wherein the processor is configured to evaluate the obtained location information in relation to the at least one cell-independent geographical zone related to the UE, and wherein the sending unit is configured to respond to the obtained location information.

51. A method of provisioning services related to a subscriber-related zone database, wherein a zone is a cell-independent geographical zone, the method comprising:
obtaining subscriber-related input data,
sending to a location server a zone-related service request dependent on the obtained input data,
obtaining a zone-related service response from the location server, and
providing the zone-related service response to enable management of the subscriber-related zone database.

52. The method of provisioning according to claim 51, wherein sending a zone-related service request comprises sending a zone-related service message request, and wherein obtaining a zone-related service response comprises obtaining a zone-related service message response.
